(19) United States
(12) Patent Application Publication
(10) Pub. No.: US 2010/0058351 A1
(43) Pub. Date: Mar. 4, 2010

(54) INFORMATION PROCESSING APPARATUS AND INFORMATION PROCESSING METHOD

(75) Inventor: Hideyuki Yahagi, Yokohama-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/509,758

(22) Filed: Jul. 27, 2009

(30) Foreign Application Priority Data
Sep. 1, 2008 (JP) 2008-223918

(51) Int. Cl. G06F 9/46

(52) U.S. Cl. 718/104

(57) ABSTRACT

A system resource leak is reliably detected and released. The invention is an information processing apparatus which allocates/releases a system resource in response to a request from a process. The apparatus includes a unit configured to, when a request to allocate the system resource is sent, store an identifier which is assigned to a job including the process as a request source, and system resource information in a management table, a unit configured to, when a request to release the system resource is sent, delete the corresponding system resource information from the management table, a unit configured to, each time the job ends, refer to the management table to determine whether the management table stores an identifier assigned to the job, and a unit configured to, when it is determined that the management table stores the identifier, release the system resource specified by the corresponding system resource information.

### BACKGROUND OF THE INVENTION

1. Field of the Invention

The present invention relates to an information processing technique for preventing an information processing apparatus from causing an operation halt due to a system resource leak.

2. Description of the Related Art

In general, when executing an application program, processing of allocating and releasing system resources such as files, ports, semaphores, and memories is repeatedly performed via a function provided by an operating system (OS).

If an application program does not execute processing of releasing system resources, allocated system resources are wastefully kept occupied without being used at all. Such state is generally called a system resource leak.

Since it is possible to return to a normal state by restarting the OS (i.e., it is possible to eliminate a system resource leak), a system resource leak rarely poses a serious problem in an apparatus having a short continuous operation time.

In an apparatus (e.g., industrial manufacturing apparatus) having a long continuous operation time, however, if a system resource leak occurs, system resources are wastefully consumed for a long time, thereby causing the apparatus to halt its operation in some cases.

In general, an application program detects and removes causes of a system resource leak in a test process before shipment. In some cases, however, it may be difficult to completely remove the causes of a system resource leak in the test process before shipment.

For example, the operation of a semiconductor exposure apparatus which performs semiconductor wafer printing is determined based on an exposure recipe describing exposure conditions and procedures, and a combination of apparatus settings. This requires a large number of parameters, and a customer sets the parameters based on a production plan of a factory line. For this reason, in fact, it is impossible to check all combinations of parameters in the test process.

Such apparatus is desirably configured to avoid an operation halt even if a system resource leak occurs.

To implement such arrangement, Japanese Patent Laid-Open No. 2002-358204 has proposed a method of detecting and eliminating a system resource leak in a single process by providing a management process for detecting system resource allocation and releasing.

Furthermore, Japanese Patent Laid-Open No. 2006-331213 has proposed the following method. That is, if system resource allocation and releasing in each process is detected, the detection result is registered in a management table. When predetermined processes end, the presence/absence of an unreleased system resource is determined.

The method disclosed in Japanese Patent Laid-Open No. 2002-358204 can detect a leak of system resources allocated to a single process but can hardly accurately detect a leak of system resources allocated to a plurality of processes.

On the other hand, the method disclosed in Japanese Patent Laid-Open No. 2006-331213 can detect a system resource leak even if a plurality of processes operate in conjunction with each other.

However, since the presence/absence of a system resource leak is determined at the end of all processes registered in the management table, for example, existence of a resident process makes it impossible to accurately determine the presence/absence of a system resource leak.

Furthermore, the user needs to register all the processes in the management table in advance. If the size of an application program becomes large and the number of processes to be executed becomes enormous, the work load on the user increases. In this case, therefore, the method is not practical.

### SUMMARY OF THE INVENTION

The present invention has been made in consideration of the aforementioned problems.

An information processing apparatus according to the present invention has the following arrangement. That is an information processing apparatus which allocates or releases a system resource in response to a request from a process generated by executing a program, comprising: a first storage unit configured to, when a request to allocate the system resource is sent, store an identifier which is assigned to a job including the process as a request source and is contained in the request, and information on the system resource in correspondence with each other in a management table; a deletion unit configured to, when a request to release the system resource is sent, delete the information on the system resource corresponding to the request together with the corresponding identifier from the management table; a determination unit configured to, each time the job ends, refer to the management table to determine whether the management table stores the identifier assigned to the job; and a releasing unit configured to, when the determination unit determines that the management table stores the identifier, release the system resource specified by the information on the system resource corresponding to the stored identifier.

According to the present invention, it is possible to provide an information processing technique capable of reliably detecting and eliminating a system resource leak without increasing the user's workload.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the arrangement of an information processing apparatus 100 according to an embodiment of the present invention;

FIG. 2 is a block diagram showing the functional configuration of a system resource management function implemented in the information processing apparatus 100;

FIG. 3 is a view showing an example of a system resource information management table 231;

FIG. 4 is a view showing an example of a system resource management target exclusion condition management table 232;

FIG. 5 is a flowchart illustrating the procedure of system resource management processing by a system resource management program 220;

FIG. 6 is a flowchart illustrating details of system resource allocation processing;

FIG. 7 is a flowchart illustrating details of system resource releasing processing;

FIG. 8 is a flowchart illustrating details of system resource leak elimination processing:

FIG. 9 is a view showing an example of a function provided by a system resource leak detection mechanism 221;

FIG. 10 is a view showing an example of an allocation function for a system resource 250 provided by a system resource management mechanism 223; and

FIG. 11 is a view showing an example of a releasing function for the system resource 250 provided by the system resource management mechanism 223.

### DESCRIPTION OF THE EMBODIMENTS

Embodiments of the present invention will now be described in detail in accordance with the accompanying drawings.

### First Embodiment

### <1. Arrangement of Information Processing Apparatus>

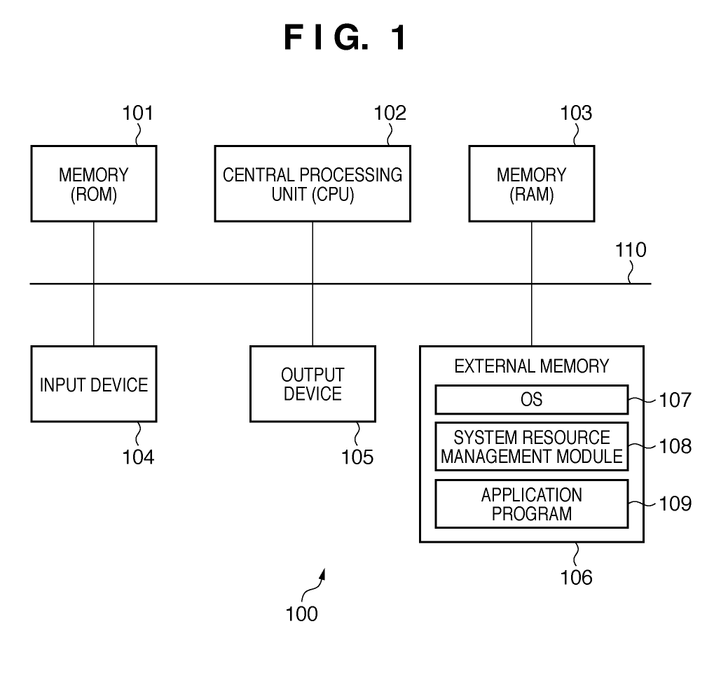

First, the arrangement of an information processing apparatus according to an embodiment of the present invention will be explained. FIG. 1 is a block diagram showing the arrangement of an information processing apparatus 100 according to the embodiment of the present invention.

Referring to FIG. 1, reference numeral 101 denotes a memory (ROM); 102, a central processing unit (CPU); 103, a memory (RAM); 104, an input device; 105, an output device; 106, an external memory; and 110, a bus.

The external memory 106 stores an OS 107 for providing a function of allocating system resources, a system resource management module 108 for managing the system resources, and an application program 109 including a plurality of jobs.

Under the control of the central processing unit (CPU) 102, these programs and the like are loaded in the memory (RAM) 103 via the bus 110 as needed, and are then executed by the central processing unit 102.

### <2. Functional Configuration of System Resource Management Function>

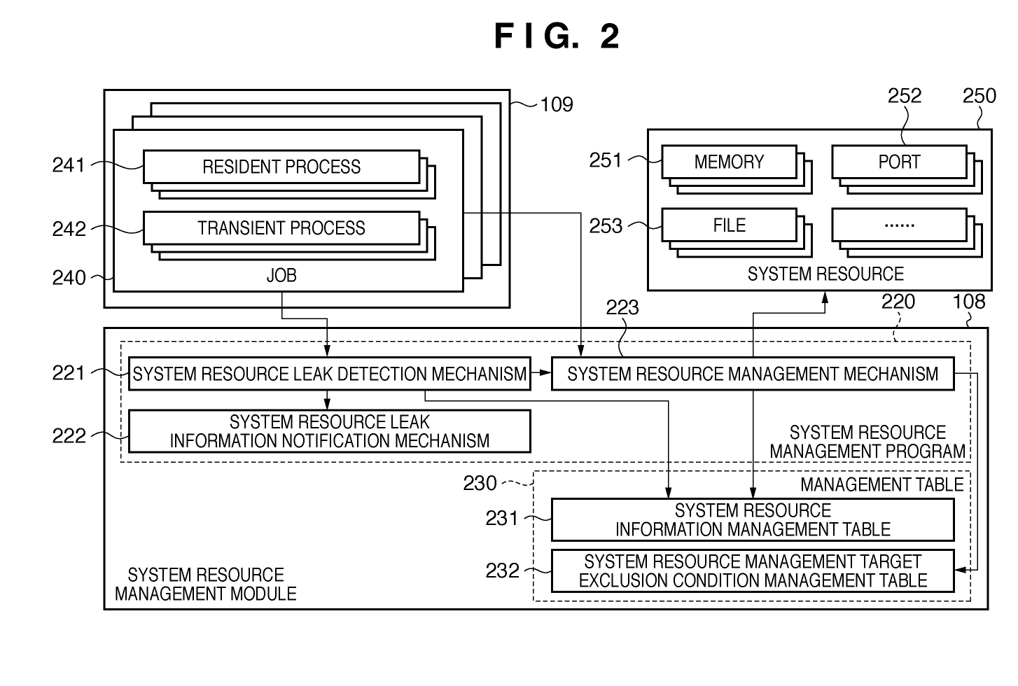

FIG. 2 is a block diagram showing the functional configuration of a system resource management function implemented in the information processing apparatus 100. As shown in FIG. 2, the system resource management function includes a system resource 250, the application program 109 for requesting allocation/releasing of the system resource 250, and the system resource management module 108 for managing the system resource 250.

The application program 109 includes a plurality of jobs 240. Each job 240 includes at least one of a resident process 241 and a transient process 242. Note that a “process” is generated by executing a program, and is a smallest unit of execution in processing using a system resource, or is a series of processes when the program is seen from the CPU side. A “job” is a set of operations to be executed by a computer when seen from the user side.

In this embodiment, the resident process 241 is a process which is activated upon activation of the information processing apparatus 100, and disappears when the information processing apparatus 100 halts. Furthermore, the processing of the resident process 241 is triggered by, for example, message reception from another process. On the other hand, the transient process 242 is a process which is activated at the start of its processing, and disappears at the end of the processing.

In this embodiment, each job 240 is assigned an execution ID (to be referred to as a job execution ID hereinafter) upon execution of it. The resident process 241 and transient process 242 within each job 240 are characterized in that they are notified of a job execution ID upon execution of their processing, respectively.

The system resource 250 includes memories 251, ports 252, and files 253 which are allocated to the resident process 241 or transient process 242 at the time of execution of each job 240.

The system resource management module 108 includes a system resource management program 220 and management table 230.

The management table 230 includes a system resource management target exclusion condition management table (condition table) 232 in which registration conditions for registering the allocation/releasing of the system resource 250 (i.e., for determining management targets) are given (the second storage unit). More specifically, the registration conditions for determining management targets are rules associated with the system resource 250 not to be registered in a system resource information management table 231.

The management table 230 includes the system resource information management table 231 (the first storage unit). The system resource information management table 231 stores/deletes information on the system resource 250 to be managed, and source code information such as a file name (class name) and a function name at a location where the system resource 250 is allocated. With this operation, the allocation/releasing of the system resource 250 to be managed is registered in the system resource information management table 231. Details of the management table 230 will be described later.

The system resource management program 220 is a program for allocating/releasing, based on an instruction from the application program 109, the system resource 250 via a function provided by the OS (not shown).

More specifically, the system resource management program 220 includes a system resource management mechanism 223, system resource leak detection mechanism 221, and system resource leak information notification mechanism 222, each of which operates as follows.

(1) System Resource Management Mechanism 223

The mechanism 223 allocates/releases the system resource 250 via the function provided by the OS (not shown). To allocate the system resource 250, the mechanism 223 refers to the system resource management target exclusion condition management table 232. If the conditions are not met, the mechanism 223 stores a corresponding job execution ID, information on the system resource 250, and source code information in correspondence with each other in the system resource information management table 231. To release the system resource 250, the mechanism 223 deletes the corresponding job execution ID, the information on the system resource 250, and the source code information from the system resource information management table 231.

(2) System Resource Leak Detection Mechanism 221

When execution of each job 240 ends, the mechanism 221 refers to the system resource information management table 231 to determine whether the table 231 stores information on the system resource 250 allocated to the resident process 241 or transient process 242 within the corresponding job 240. If the mechanism 221 determines that the table 231 stores the information on the system resource 250, it determines that a system resource leak has occurred, and then instructs the system resource management mechanism 223 to release the system resource 250. Furthermore, the mechanism 221 notifies the system resource leak information notification mechanism 222 that the system resource leak has occurred.

(3) System Resource Leak Information Notification Mechanism 222

If, at the end of execution of each job 240, the mechanism 222 receives a notification from the system resource leak detection mechanism 221 that a system resource leak has occurred, it notifies the user (e.g., a program developer) of corresponding source code information.

### <3. Structure of Management Table>

Detail of the management table 230 will now be explained.

<3.1 Structure of System Resource Information Management Table>

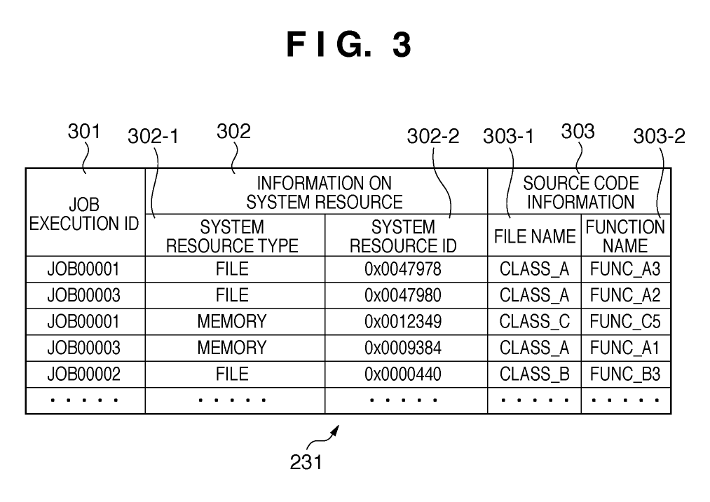

FIG. 3 is a view showing an example of the system resource information management table 231. As shown in FIG. 3, a job execution ID 301, information 302 on a system resource, and source code information 303 are registered in correspondence with each other in the system resource information management table 231.

The information 302 on a system resource includes a system resource type 302-1 and system resource ID 302-2. The source code information 303 includes a file name 303-1 and function name 303-2.

The system resource information management table 231 has a structure so as to be able to manage, in correspondence with each job execution ID, a system resource type, system resource ID, and source code information (file name, function name, and the like) for specifying a location where a system resource is allocated. The present invention is not limited to a format shown in FIG. 3.

If, for example, the system resource management mechanism 223 allocates a system resource by executing a system call provided by the OS, the system resource ID 302-2 stores the return value of the system call. More particularly, the system resource ID 302-2 stores a file descriptor when the system resource is a file, and stores the start address of an allocated area when the system resource is a memory.

<3.2 Structure of System Resource Management Target Exclusion Condition Management Table>

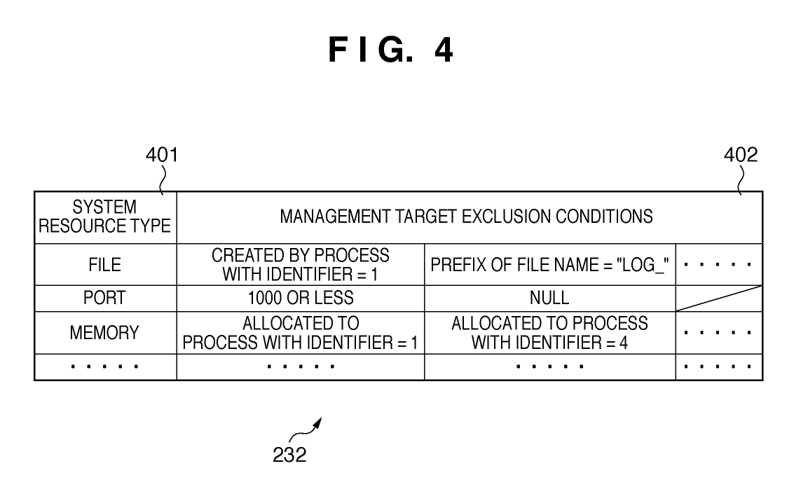

FIG. 4 is a view showing an example of the system resource management target exclusion condition management table 232. As shown in FIG. 4, in the system resource management target exclusion condition management table 232, conditions for the system resource 250 not to be managed in the system resource information management table 231 (management target exclusion conditions 402) are given for each system resource type 401.

Note that the format of the system resource management target exclusion condition management table 232 is not limited to that shown in FIG. 4.

### <4. Procedure of System Resource Management Processing by System Resource Management Program>

The procedure of system resource management processing by the system resource management program 220 will be described next.

<4.1 Procedure of Processing as a Whole>

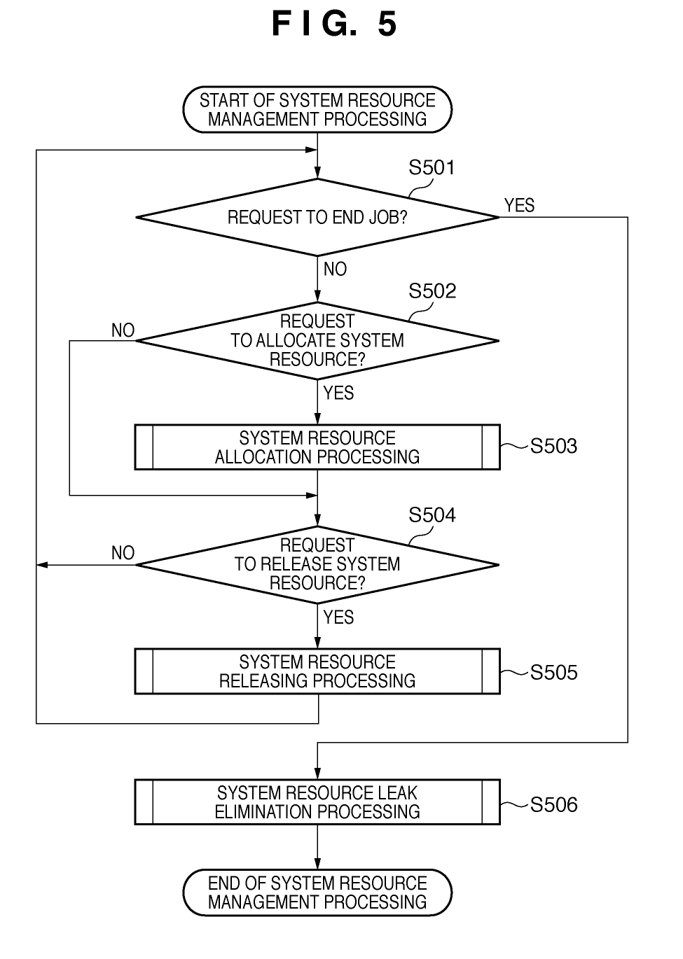

FIG. 5 is a flowchart illustrating the procedure of system resource management processing by the system resource management program 220.

In step S501, it is determined whether the system resource leak detection mechanism 221 has been notified of a processing end request from a job 240. The job 240 notifies the system resource leak detection mechanism 221 of a processing end notification at the end of the processing.

If it is determined that the mechanism 221 has been notified of a processing end request, the process advances to step S506; otherwise, the process advances to step S502.

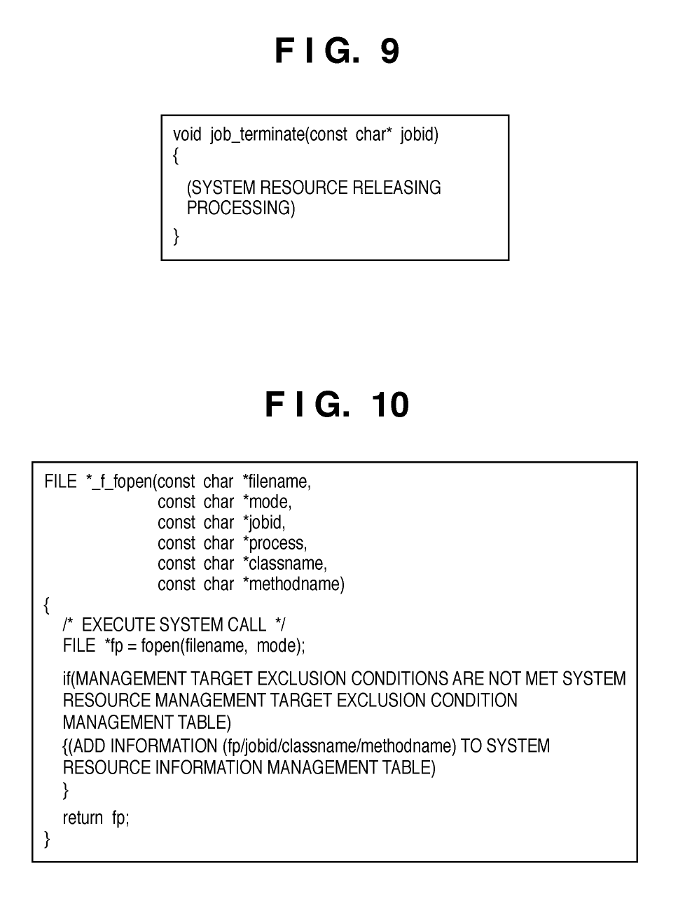

Assume that the processing end request sent from the job 240 contains at least a job execution ID. This notification processing is performed using, for example, message communication and a function (see, e.g., FIG. 9) provided by the system resource leak detection mechanism 221. The present invention, however, is not limited to this.

In step S502, it is determined whether the system resource management mechanism 223 has been notified of a system resource allocation request from a resident process 241 or transient process 242 within the running job 240.

If it is determined that the mechanism 223 has been notified of a system resource allocation request, the process advances to step S503; otherwise, the process advances to step S504.

Assume that the system resource allocation request contains at least the job execution ID, information on the resident process 241 or transient process 242, information on the system resource 250 to be allocated, and source code information. This notification processing is performed using, e.g., message communication and a system resource allocation function (see, e.g., FIG. 10) provided by the system resource management mechanism 223 for each system resource type. The present invention, however, is not limited to this.

The information on the resident process 241 or transient process 242 is used for determination in system resource allocation processing (details of the processing contents will be described later). For this reason, this is information which allows uniquely identifying the resident process 241 or transient process 242. In this embodiment, an identifier (different from a process ID dynamically assigned by the OS) assigned at the time of development of a program is used.

The information on the system resource 250 contains information to be used when the system resource management mechanism 223 allocates the system resource 250 in system resource allocation processing (details of the processing contents will be described later), including a file name and a memory size to be allocated.

The source code information contains information which allows specifying the location of a source code that has allocated the system resource 250. In this embodiment, the source code information contains a file name and function name.

In step S503, the system resource management mechanism 223 executes system resource allocation processing (details of the processing contents will be described later). By executing the system resource allocation processing (step S503), the resident process 241 or transient process 242 acquires information (the system resource ID 302-2) on the allocated system resource 250.

In step S504, it is determined whether the system resource management mechanism 223 has been notified of a system resource releasing request from the resident process 241 or transient process 242.

If it is determined that the mechanism 223 has been notified of a system resource releasing request, the process advances to step S505; otherwise, the process advances to step S501.

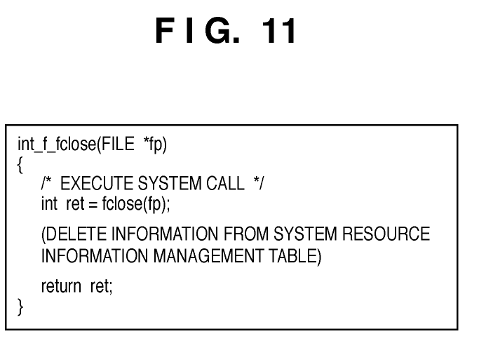

The system resource releasing request sent from the resident process 241 or transient process 242 contains at least the system resource ID. This notification processing is performed using, for example, message communication and a system resource releasing function (see, e.g., FIG. 11) provided by the system resource management mechanism 223 for each system resource type. The present invention, however, is not limited to this.

In step S505, the system resource management mechanism 223 executes system resource releasing processing (details of the processing contents will be described later). By executing the system resource releasing processing (step S505), the resident process 241 or transient process 242 acquires the releasing result of the system resource 250.

In step S506, the system resource leak detection mechanism 221 executes system resource leak eliminating processing (details of the processing contents will be described later).

<4.2 Procedure of System Resource Allocation Processing>

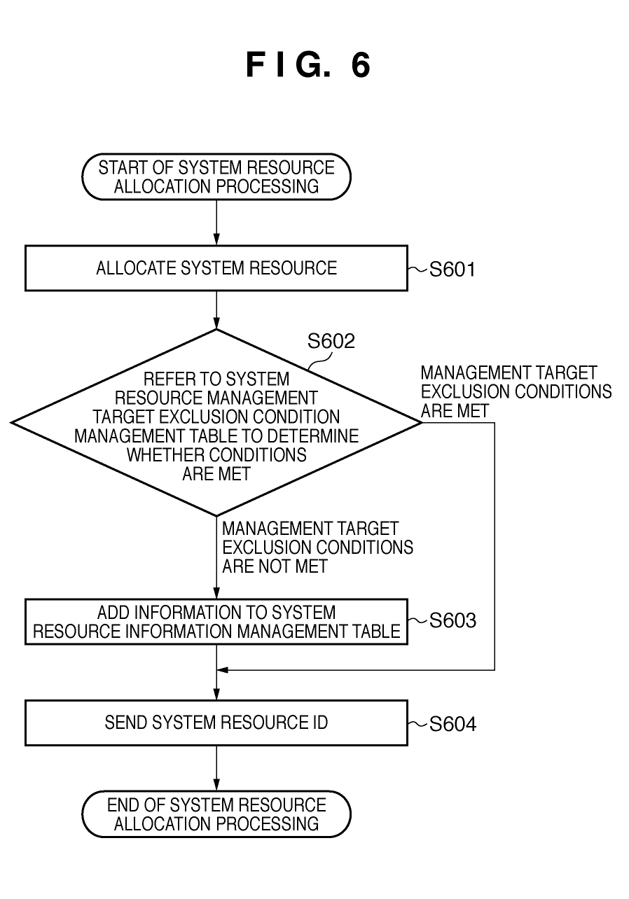

Details of the system resource allocation processing in step S503 will now be explained. FIG. 6 is a flowchart illustrating details of the system resource allocation processing.

In step S601, the system resource management mechanism 223 allocates the corresponding system resource 250 based on the notified information on the system resource 250. More specifically, the mechanism 223 executes a system call provided by the OS. The present invention, however, is not limited to this.

In step S602, the system resource management mechanism 223 refers to the system resource management target exclusion condition management table 232 to determine whether conditions which match the notified pieces of information are given.

If it is determined that the matching conditions are given, the process advances to step S604; otherwise, the process advances to step S603.

If, for example, a file name=“LOG_{—}001.log” is sent as the information on the system resource 250, it is determined based on FIG. 4 that conditions which match the management target exclusion conditions 402 are given. Therefore, the allocated system resource (a file in this case) is not to be managed in the system resource information management table 231.

In step S603, the system resource management mechanism 223 registers, in the system resource information management table 231, the job execution ID, the information on the system resource 250, and the source code information in correspondence with each other.

In step S604, the system resource management mechanism 223 notifies a request source of the system resource allocation processing of the system resource ID, and ends the system resource allocation processing. This notification processing is performed using, for example, message communication and the return value of the system resource allocation function (see, e.g., FIG. 10) provided by the system resource management mechanism 223 for each system resource type. The present invention, however, is not limited to this.

<4.3 Procedure of System Resource Releasing Processing>

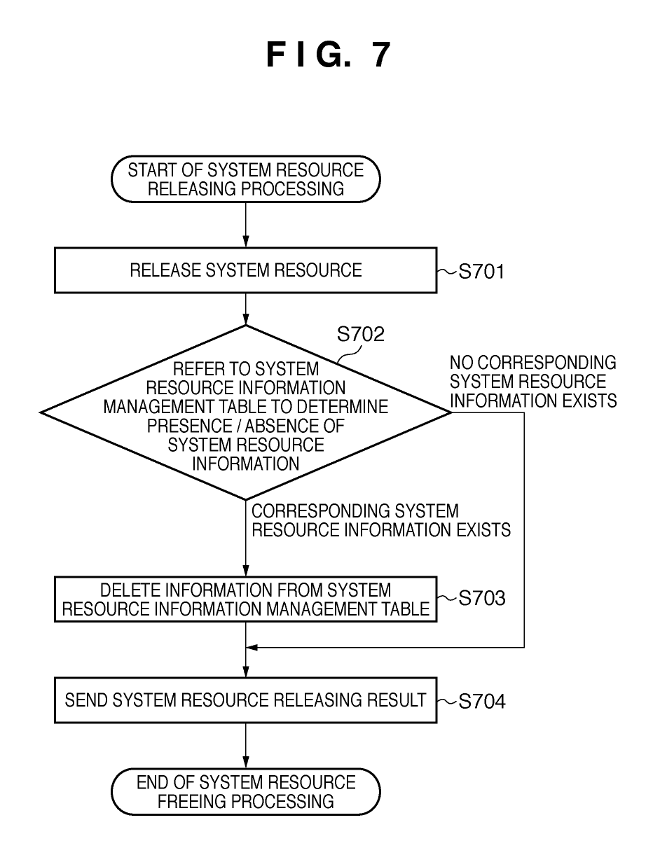

Details of the system resource releasing processing in step S505 will now be described. FIG. 7 is a flowchart illustrating details of the system resource releasing processing.

In step S701, the system resource management mechanism 223 releases the corresponding system resource 250 based on the notified system resource ID. More specifically, the mechanism 223 executes a system call provided by the OS. The present invention, however, is not limited to this.

In step S702, the system resource management mechanism 223 determines whether the system resource information management table 231 stores the notified system resource ID. If it is determined that the table 231 stores the system resource ID, the process advances to step S703; otherwise, the process advances to step S704.

In step S703, the system resource management mechanism 223 deletes a record including the notified system resource ID from the system resource information management table 231.

In step S704, the system resource management mechanism 223 notifies a request source of the system resource releasing processing of the releasing result (releasing success or releasing failure) of the system resource 250, and ends the system resource releasing processing.

This notification processing is performed using, for example, message communication and the return value of the system resource releasing function (see, e.g., FIG. 11) provided by the system resource management mechanism 223 for each system resource type. The present invention, however, is not limited to this.

<4.4 Procedure of System Resource Leak Elimination Processing>

Details of the system resource leak elimination processing in step S506 will be explained next.

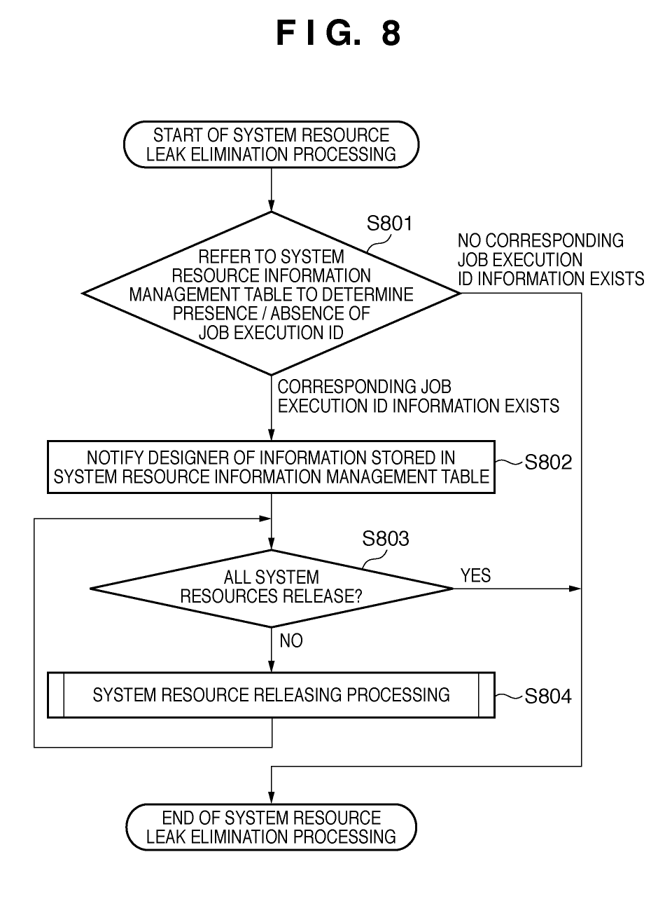

FIG. 8 is a flowchart illustrating details of the system resource leak elimination processing.

In step S801, the system resource leak detection mechanism 221 refers to the system resource information management table 231. Then, the mechanism 221 determines whether there exists a record including the job execution ID (the job execution ID of the job for which a job end request is made) acquired in step S501.

If it is determined that a corresponding record exists, it is determined that a system resource leak has occurred, and the process advances to step S802. If it is determined that no corresponding record exists, it is determined that no system resource leak has occurred, and the system resource leak elimination processing ends.

In step S802, the system resource leak information notification mechanism 222 notifies the user (e.g., a program developer) of the pieces of information stored in the system resource information management table 231. Note that the notification contents contain the information (e.g., a file name and port number) on the system resource 250 which cannot be released. The notification contents also contain the source code information (e.g., a file name and function name) which allows to specify the location of the source code that has allocated the corresponding system resource 250. The present invention, however, is not limited to this. This notification processing is performed using, for example, email but the present invention is not limited to this.

In step S803, the system resource leak detection mechanism 221 determines whether all the system resources 250 associated with the job execution ID acquired in step S501 have been released. If the mechanism 221 determines that not all the system resources 250 have been released yet, the process advances to step S804; otherwise, the system resource leak elimination processing ends.

In step S804, the system resource leak detection mechanism 221 releases the system resource based on the system resource ID registered in the system resource information management table 231. The processing contents are the same as in step S505 of FIG. 5, and a detailed description thereof will be omitted.

As is apparent from the above explanation, in this embodiment, in response to a request from a process, information on a system resource to be allocated/released is managed by storing it in a management table. Furthermore, when execution of each job ends, the presence/absence of occurrence of a system resource leak is determined for a system resource managed in the management table. If it is determined that a system resource leak has occurred, processing of eliminating the system resource leak is executed at the end of the execution of the job.

Consequently, this can eliminate the need to register all processes in the management table in advance, thereby reducing the work load on the user. It is also possible to accurately detect a system resource leak even if there exists a system resource allocated to a plurality of processes. Furthermore, since system resource leak elimination processing is executed when execution of each job ends, it is possible to reliably prevent an information processing apparatus from causing an operation halt even if a system resource leak occurs.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-223918, filed Sep. 1, 2008, which is hereby incorporated by reference herein in its entirety.

What is claimed is:

1. An information processing apparatus which allocates or releases a system resource in response to a request from a process generated by executing a program, comprising:
a first storage unit configured to, when a request to allocate the system resource is sent, store an identifier which is assigned to a job including the process as a request source and is contained in the request, and information on the system resource in correspondence with each other in a management table;
a deletion unit configured to, when a request to release the system resource is sent, delete the information on the system resource corresponding to the request together with the corresponding identifier from the management table;
a determination unit configured to, each time the job ends, refer to the management table to determine whether the management table stores the identifier assigned to the job; and
a releasing unit configured to, when the determination unit determines that the management table stores the identifier, release the system resource specified by the information on the system resource corresponding to the stored identifier.

2. The apparatus according to claim 1, further comprising a second storage unit configured to store a condition table in which a condition for storage in the management table is given,
wherein when a request to allocate the system resource is sent, the first storage unit determines based on the condition given in the condition table whether to perform the storage process.

3. The apparatus according to claim 1, wherein the first storage unit stores, in correspondence with the identifier, source code information indicating a location where the system resource is allocated.

4. The apparatus according to claim 3, further comprising a notification unit configured to, when the determination unit determines that the management table stores the identifier, notify a user of the information on the system resource corresponding to the stored identifier, and the source code information.

5. An information processing method for an information processing apparatus which allocates or releases a system resource in response to a request from a process generated by executing a program, comprising:
a storage step of, when a request to allocate the system resource is sent, storing an identifier which is assigned to a job including the process as a request source and is contained in the request, and information on the system resource in correspondence with each other in a management table;
a deletion step of, when a request to release the system resource is sent, deleting the information on the system resource corresponding to the request together with the corresponding identifier from the management table;
a determination step of, each time the job ends, referring to the management table to determine whether the management table stores the identifier assigned to the job; and
a releasing step of, when it is determined in the determination step that the management table stores the identifier, releasing the system resource specified by the information on the system resource corresponding to the stored identifier.

6. A computer-readable storage medium storing a program for causing a computer to execute the information processing method according to claim 5.
